(19) United States
(12) Patent Application Publication
(10) Pub. No.: US 2015/0347745 A1
(43) Pub. Date: Dec. 3, 2015

(54) METHOD FOR EXTRACTING EXECUTABLE CODE OF APPLICATION USING MEMORY DUMP

(71) Applicant: The Industry & Academic Cooperation in Chungnam National University (IAC), Daejeon (KR)

(72) Inventors: Jaecheol RYOU, Daejeon (KR); Dongwoo KIM, Daejeon (KR); Wootak JUNG, Daejeon (KR)

(21) Appl. No.: 14/719,212

(22) Filed: May 21, 2015

(30) Foreign Application Priority Data
May 28, 2014 (KR) 10-2014-0064560

(51) Int. Cl. G06F 21/51; G06F 9/45

(52) U.S. Cl. CPC G06F 21/51; G06F 8/53; G06F 2221/033

(57) ABSTRACT

Disclosed is a method for extracting an executable code by dumping a working memory on a storage memory at the moment when an Android platform loads an executable code on the working memory after decrypting the executable code. The method includes reading a name of a user-designated process from a dump configuration file of the storage memory; checking a name of an execution process running on the emulator; determining whether the name of the user-designated process is identical to the name of the execution process; determining whether a name of a parent process of the execution process is “zygote”, when the name of the user-designated process is identical to the name of the execution process; and dumping an executable code of the execution process on a designated directory of the storage memory when the name of the parent process of the execution process is “zygote”.

### STATEMENTS REGARDING SPONSORED RESEARCH

This research was supported by the MSIP (Ministry of Science, ICT&Future Planning), Korea, under the ITRC (Information Technology Research Center)) support program (NIPA-2014-H0301-14-1010) supervised by the NIPA (National IT Industry Promotion Agency).

This research was supported by Next-Generation Information Computing Development Program through the National Research Foundation of Korea (NRF) funded by the Ministry of Science, ICT & Future Planning (No. NRF-2014M3C4A7030648).

### CROSS-REFERENCE TO RELATED APPLICATIONS

A claim for priority under 35 U.S.C. §119 is made to Korean Patent Application No. 10-2014-0064560 filed May 28, 2014, in the Korean Intellectual Property Office, the entire contents of which are hereby incorporated by reference.

### BACKGROUND

Embodiments of the inventive concepts described herein relate to an application analyzing method, and more particularly, relate to a method for extracting an executable code of an application, which runs in an Android environment, using a memory dump technique.

An application that runs at an Android environment may operate by executing a single executable file of a package file, such as classes.dex. Since the executable file has a form of bytecode, it is easy to convert the executable file into a source code using a decompile technique.

A research on obfuscation techniques and anti-analysis techniques is being made to prevent the source code from being exposed. However, the obfuscation techniques or anti-analysis techniques may permit source codes of normal and malicious applications to be prevented from being exposed. Also, in some recently found malicious applications that utilize encryption of an executable code, anti-debugging, and anti-decompiling techniques, it is difficult to analyze the malicious applications in detail based on conventional analysis tools and methods. Thus, a new method is required to secure an executable code by avoiding a protection technique applied to the malicious applications.

### SUMMARY

Embodiments of the inventive concepts provide an executable code extracting method for securing an executable code at a low level using a memory dump technique.

One aspect of embodiments of the inventive concept is directed to provide a method for extracting an executable code by dumping a working memory on a storage memory at the moment when an Android platform loads an executable code on the working memory after decrypting the executable code. The method may include reading a name of a user-designated process from a dump configuration file of the storage memory; checking a name of an execution process running on the emulator; determining whether the name of the user-designated process is identical to the name of the execution process; determining whether a name of a parent process of the execution process is “zygote”, when the name of the user-designated process is identical to the name of the execution process; and dumping an executable code of the execution process on a designated directory of the storage memory when the name of the parent process of the execution process is “zygote”.

The name of the user-designated process may be a package name of an application to extract an executable code.

The checking of a name of an execution process may include acquiring an ID value (PID) of an execution process and an ID value (PPID) of a parent process; and checking the name of the execution process from a file system using the ID value of the execution process and the ID value of the parent process.

The checking of a name of an execution process may further include reading a command line (cmdline) file of the file system to check the name of the execution process.

The method may further include converting the stored executable code into a source code using a decompile tool.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a configuration diagram for describing an executable code extracting method according to an exemplary embodiment of the inventive concept;

FIG. 2 is a flowchart schematically illustrating an executable code extracting method according to an exemplary embodiment of the inventive concept;

FIG. 3 is a flowchart schematically illustrating an executable code extracting method according to another exemplary embodiment of the inventive concept; and

FIGS. 4 to 6 are diagrams for describing an executable code extracting method according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

An executable code extracting method according to an exemplary embodiment of the inventive concept may extract an executable code of an application (hereinafter referred to as “App”) that runs at an Android environment. In general, when the App is driven on the Android platform, an executable file of the App may be loaded on a working memory, such as a Random Access Memory (RAM), and then may be executed on the working memory. For example, in case of the Android platform version 4.0.1, the App calls a DexClassLoader Application Programming Interface (API) to load the executable file on the working memory. The DexClassLoader requests a dvmDexFileOpenFromFd function at a native code layer of the Dalvik virtual machine finally. The dvmDexFileOpenFromFd function loads the executable file on the working memory after a decryption routine of the native library.

Thus, as a dump code is inserted in the dvmDexFileOpenFromFd function, a loaded executable file may be secured by dumping the working memory immediately after the dvmDexFileOpenFromFd function loads the executable file on the working memory.

However, an exception error may occur when extracting all executable files loaded on the working memory using dump code as the above-described. For example, in the event that the dump code tries to access a memory of a child process having an anti-analysis routine, a target process for extracting an executable code is abnormally terminated due to the anti-analysis function.

Thus, the executable code extracting method according to an exemplary embodiment of the inventive concept may secure an executable code by extracting an executable file that is loaded on the working memory by itself, not the child process of the App.

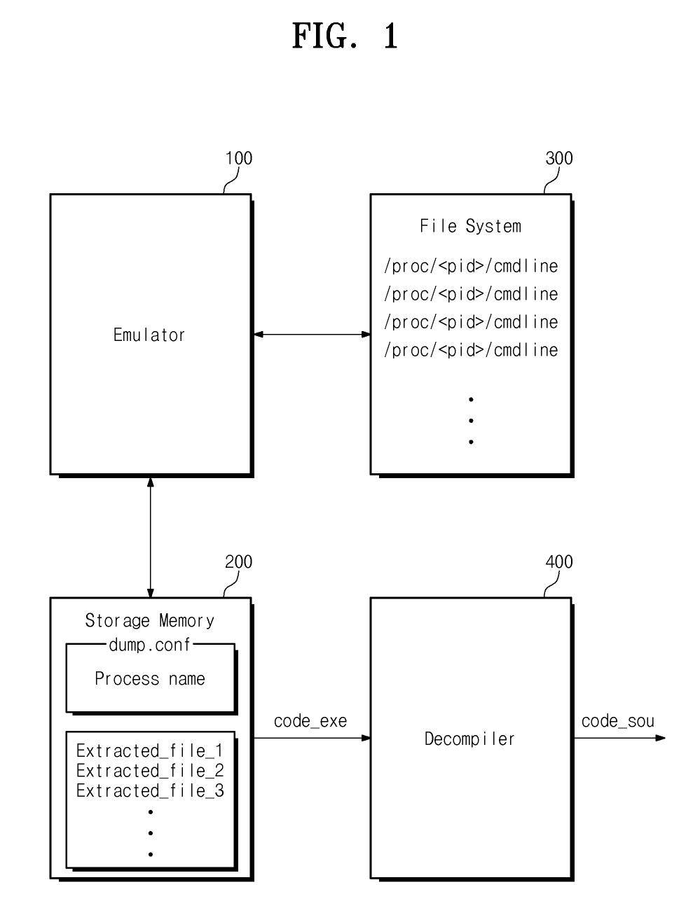

FIG. 1 is a configuration diagram for describing an executable code extracting method according to an exemplary embodiment of the inventive concept. An executable code extracting method according to an exemplary embodiment will be described with reference to FIG. 1. The executable code extracting method according to an exemplary embodiment may be executed by an emulator 100 in which a dump code is inserted. The emulator 100 extracts an executable code (code_exe) of the App using a dump configuration file (dump.conf) stored at a storage memory 200 and a command line (cmdline) file of a file system, and it stores the extracted executable code (code_exe) at the storage memory 200. The stored executable code (code_exe) is decompiled through a decompiler 400 and outputs a source code (code_sou) as the decompiling result.

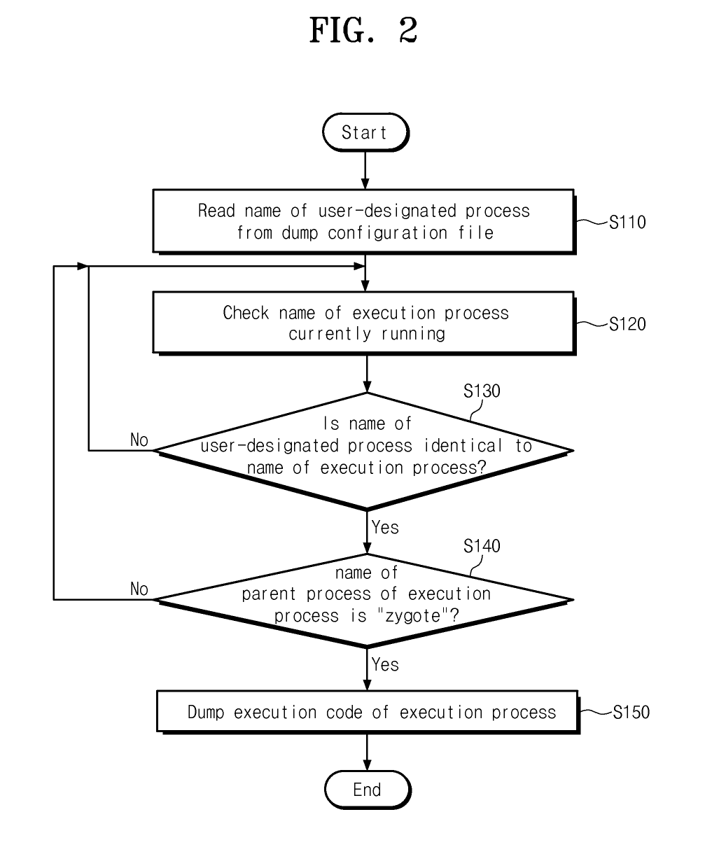

FIG. 2 is a flowchart schematically illustrating an executable code extracting method according to an exemplary embodiment of the inventive concept. An executable code extracting method according to an exemplary embodiment of the inventive concept will be more fully described with reference to FIG. 2.

First, an executable code extracting method according to an exemplary embodiment of the inventive concept may be performed by executing the App (hereinafter referred to as “target App”) corresponding to an analysis on the dumpcode-inserted emulator 100. The emulator 100 includes a Dalvik virtual machine. In the event that the emulator 100 executes the target App, as described above, the target App calls a DexclassLoader API to load an executable file on a working memory. The called DexclassLoader API requests a dvmDexFileOpenFromFd function at the Dalvik virtual machine finally. The called dvmDexFileOpenFromFd function loads an executable file on the working memory. In the executable code extracting method according to an exemplary embodiment of the inventive concept, the working memory is dumped just after the dvmDexFileOpenFromFd function loads a decrypted executable file on the working memory. Also, only an executable file corresponding to a specific process which is defined in a dump configuration file (dump.conf) is dumped, from among executable files of processes loaded on the working memory.

If the target App is executed on the emulator 100, in step S110, the emulator 100 reads a name of a user-designated process from a dump configuration file (dump.conf) that is stored at a storage memory 200. The name of the user-designated process may be used to dump an executable file to be dumped among executable files loaded on the working memory. The name of the user-designated process may be a package name of the target App. The name of the user-designated process may be acquired, for example, through an AndroidManifest.xml file of the App. The process name of the App may be obtained in various manners, not limited to this disclosure. The package name of the App thus obtained is stored in the dump configuration file (dump.conf) stored at the storage memory 200.

In step S210, the emulator 100 checks a name of an execution process that runs on the emulator 100. In the event that the App is driven on the emulator 100, a plurality of executable files including a basic executable file provided by a system may be loaded on the working memory by the dvmDexFileOpenFromFd function. The emulator 100 checks a name of a process loaded on the working memory by the dvmDexFileOpenFromFd function. The name of the process may be checked using an ID value (PID) of the loaded process.

After checking the name of the execution process, in step S130, the emulator 100 determines whether the name of the user-designated process is identical to that of the execution process. As a consequence of determining that the name of the user-designated process is not identical to that of the execution process, the emulator 100 checks a name of any other process that the dvmDexFileOpenFromFd function loads on the working memory.

As a consequence of determining that the name of the user-designated process is identical to that of the execution process, in step S140, the emulator 100 determines whether a name of a parent process of the execution process is “zygote”. The “zygote” process is a process executed at the beginning of driving the App and executes a main process after loading a class included in a framework necessary for the App to be executed and a necessary class including a platform resource. An ID value (PPID) of a parent process of Apps executed by the “zygote” process may be equal to an ID value (PID) of the “zygote” process.

When a consequence of determining indicates that a name of a parent process of the execution process is “zygote”, in step S150, the emulator 100 dumps an executable code of a relevant execution process loaded on the working memory.

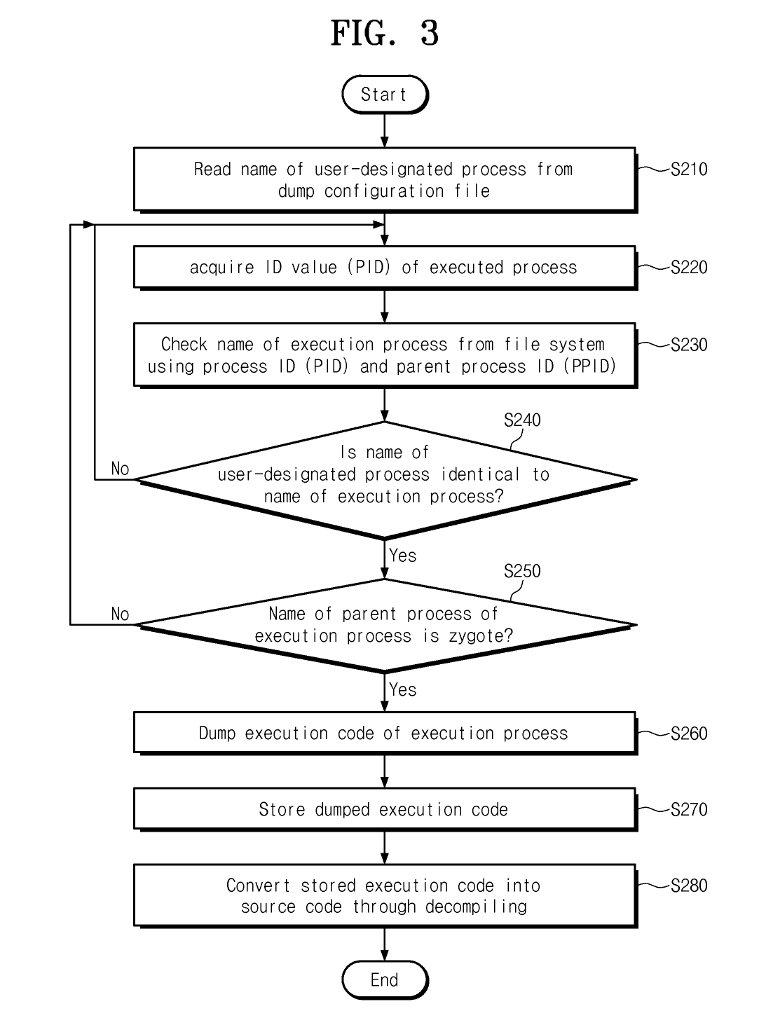

FIG. 3 is a flowchart schematically illustrating an executable code extracting method according to another exemplary embodiment of the inventive concept. An executable code extracting method according to another exemplary embodiment of the inventive concept will be more fully described with reference to FIG. 3. Steps S210, S240, S250, and S260 of FIG. 3 are substantially the same as those S110, S130, S140, and S150 of FIG. 2, and a detailed description thereof is thus omitted.

In step S220, an emulator 100 acquires an ID value (PID) of an execution process, which calls a dvmDexFileOpenFromFd function to load an executable code on a working memory, and an ID value (PPID) of a parent process. The ID values (PID, PP ID) of the execution process and the parent process may be acquired, for example, through “getpid( )” “getppid( )” system calls, respectively.

In step S230, the emulator 100 checks a name of an execution process from a file system 300 using the acquired Process ID (PID) value and Parent Process ID (PPID) value. The emulator 100 may read a command line (cmdline) file of the file system 300 to check a name of the execution process.

In step S270, the emulator 100 may store an executable code dumped in step S260. The executable code thus dumped may be stored at a designated directory of a storage memory 200.

The emulator 100 decompiles the executable code stored at the storage memory 200 through a decompiler 400 so as to be converted into a source code. In the event that the stored executable code has a DEX format, it may be decompiled using a tool such as Dex2Jar, JD-GUI, and so on. If the stored executable code has an ODEX (Optimized DEX), it may be converted into the DEX format using a tool, such as Baksmali, Smali, and so on, and the executable code converted into the DEX format may be converted into the source code through the above-described operation.

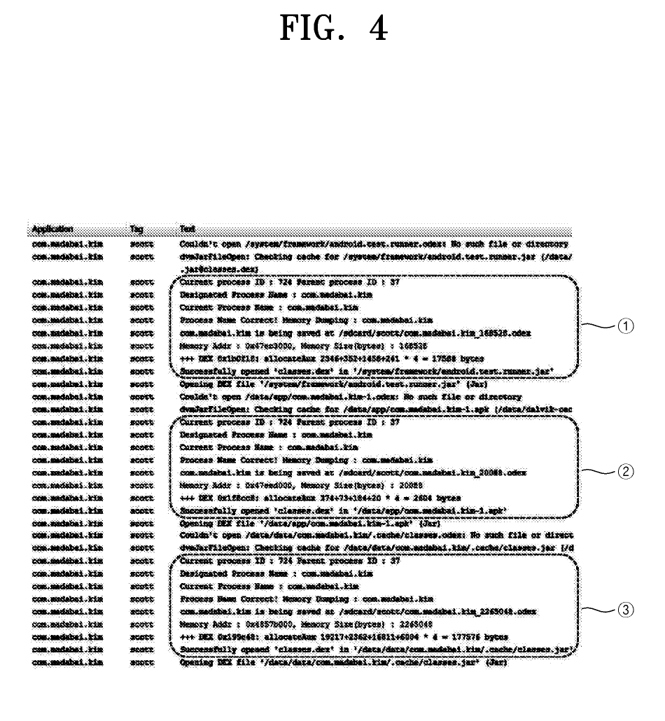

FIG. 4 is a diagram illustrating an executable code extracted from a sample App using an executable code extracting method according to an exemplary embodiment of the inventive concept. Referring to FIG. 4, a total of three executable files (\textcircled{1}, \textcircled{2}, \textcircled{3}) are extracted. According to an analysis of the extracted executable files, a first executable file (\textcircled{1}) is a default executable file where “‘android.test.runner.jar” exists. A second executable file (\textcircled{2}) is a default executable file of a sample App. A third executable file (\textcircled{3}) is an external executable file that is dynamically loaded after it is decrypted by a native library.

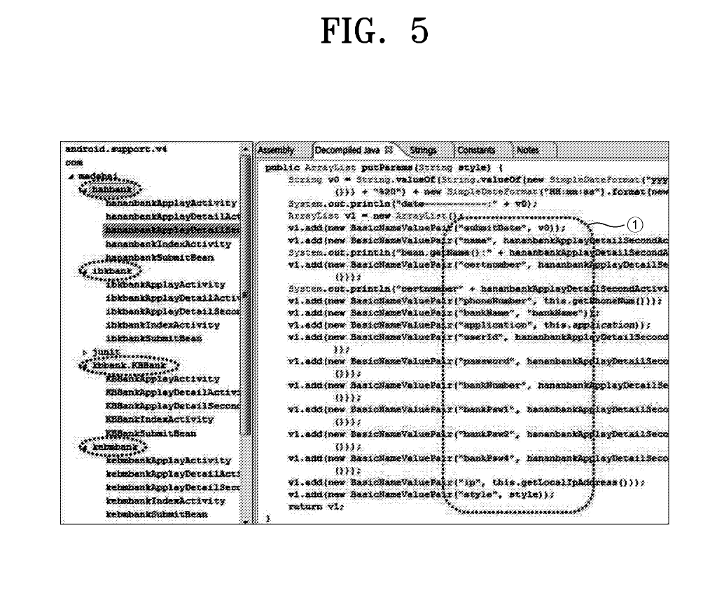

FIG. 5 is a diagram illustrating a source code obtained by decompiling a third executable file extracted in FIG. 4. Referring to a dotted box (\textcircled{1}) shown in FIG. 5, an extracted executable file may be an executable file of a malicious App for intercepting personal bank information.

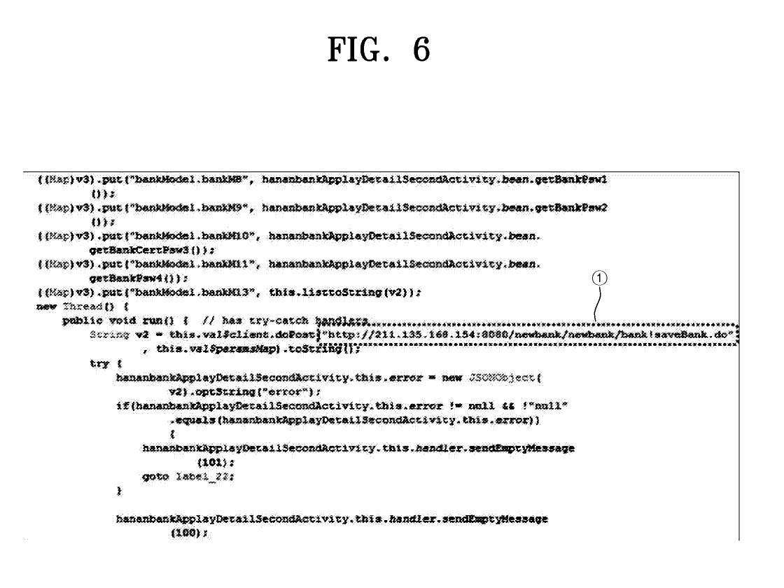

FIG. 6 is a diagram illustrating a portion of a source code converted in FIG. 5. Referring to a dotted box (\textcircled{1}) shown in FIG. 6, there is identified an address of a server to which personal bank information is transferred by a malicious App. Thus, in an executable code extracting method according to an exemplary embodiment of the inventive concept, a type of a malicious App and an address of a server to which extracted bank information is transferred are identified, thereby making it possible to cope with the malicious App in the concrete.

According to an exemplary embodiment of the inventive concept, an executable file of a malicious App to which an anti-analysis technique (e.g., encryption) is applied may be extracted from a working memory in a decrypted form.

According to an exemplary embodiment of the inventive concept, it is possible to extract an executable file of a malicious App at a low level.

According to an exemplary embodiment of the inventive concept, it is possible to shorten a time taken to extract an executable file of a malicious App.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for extracting an executable code by dumping a working memory on a storage memory at the moment when an Android platform loads an executable code on the working memory after decrypting the executable code, the method comprising:
reading a name of a user-designated process from a dump configuration file of the storage memory;
checking a name of an execution process running on the Android platform;
determining whether the name of the user-designated process is identical to the name of the execution process;
determining whether a name of a parent process of the execution process is “zygote”, when the name of the user-designated process is identical to the name of the execution process; and
dumping an executable code of the execution process on a designated directory of the storage memory when the name of the parent process of the execution process is “zygote”.

2. The method of claim 1, wherein the name of the user-designated process is a package name of an application to extract an executable code.

3. The method of claim 1, wherein the checking of a name of an execution process comprises:
acquiring an ID value (PID) of an execution process and an ID value (PPID) of a parent process; and
checking the name of the execution process from a file system using the ID value of the execution process and the ID value of the parent process.

4. The method of claim 3, wherein the checking of a name of an execution process further comprises:
reading a command line (cmdline) file of the file system to check the name of the execution process.

5. The method of claim 1, further comprising:
converting the dumped executable code into a source code using a decompile tool.
